(19) United States
(12) Patent Application Publication
(10) Pub. No.: US 2003/0036985 A1
(43) Pub. Date: Feb. 20, 2003

(54) Product locating system for use in a store or other facility

(76) Inventor: Mark J. Soderholm, Bakersfield, CA (US)

Correspondence Address: Richard A. Ryan, RYAN & ENGNATH, Suite 104, 8469 N. Millbrook, Fresno, CA, 93720, US

(21) Appl. No.: 10/219,680

(22) Filed: Aug. 14, 2002

Related U.S. Application Data
(60) Provisional application No. 60/312,676, filed on Aug. 15, 2001.

(51) Int. Cl. G06F 17/60

(52) U.S. Cl. 705/28

(57) ABSTRACT

A product locating system having one or more targeting units attached to the ceiling or other overhead location in a store or product storage facility, a computer system in communication with the targeting units and a scan gun for reading UPC codes on the products in the store or facility. The scan gun is in communication with the targeting units and computer system. The system is used to quickly and accurately identify the location of products on the shelves of the store or facility by projecting a beam of light toward the object on the shelf or the location on the shelf where the object is normally placed. The system reduces manpower for stocking products on the shelf, finds extra stock of the products and assists in inventory control. In addition, the system can be used to locate expired products and products which have been recalled.

### CROSS-REFERENCE TO RELATED APPLICATIONS

This application claims the benefit of U.S. Provisional Application No. 60/312,676 filed Aug. 15, 2001.

### BACKGROUND OF THE INVENTION

A. Field of the Invention

The field of the present invention relates generally to methods used for identifying the location of an object in a building, such as a store, wholesale storage facility and other facilities. More particularly, the present invention relates to such methods which can quickly and effectively identify the location of objects, such as merchandise, in a store or other facility for storing various types of objects.

B. Background

Most modern retail stores, including stores selling groceries, electronics and various other retail products, utilize relatively sophisticated computerized systems to track inventory, prices and other pertinent product information. Some of this information is typically displayed with the product at its location on the shelf in the store. Wholesale storage facilities, including those directly associated with a retail establishment, also utilize these same types of systems to track similar information for a variety of products. The development of the Universal Product Code (“UPC”) markings or codes for products and modern computer systems have facilitated the improved ability to track and quantify important information relating to products on the shelf of these stores and storage facilities. When a customer removes a product from the shelf or a retail store and takes it to the checkout area of the store, the clerk will scan the product to obtain the price of the product and any current promotional incentives associated with the product (i.e., price discounts, two-for-one specials and etc.). The sale of the item is then transmitted to a central computer where the inventory of that product is adjusted accordingly. Based on information pertaining to the sale of the item, and in some circumstances to the non-sale of an item (i.e., the item remaining on the shelf), the management of the store can make decisions regarding the product, such as the quantity and timing of future wholesale purchases of the item and whether it is necessary to lower the price of any remaining items in inventory to better sell the product.

A unique UPC code is placed on virtually every product to identify the product when it is scanned with a portable scan gun, such as those available from Telxon® or Symbol®, or a mounted scanner at the checkout counter. The typical scan gun is a hand-held device that reads the UPC code on a product to retrieve stored information regarding the product. Depending on what information is stored in the computer, the information which can be retrieved by the hand-held scan gun includes the standard retail price, any price or sale specials, cost of the product, inventory on hand and a description of the product. In addition to being useful when a customer is purchasing the product, the information is also useful for those persons doing inventory.

One of the biggest problems for managers of retail stores and other product storage facilities is the need to maintain control over the inventory of the various products in their store or facility. As is known, the ability of store employees to find and quantify the number of products on the shelves of the store, which can be quite voluminous, is a very important component of maintaining profitability for the store or facility. In addition, it is important that customers be able to find the product in order to make the purchase. If a product is identified as being in inventory, but it is out of place, the customer will not be able to purchase it and the store will purchase additional inventory that is not needed to satisfy customer demand. There are many reasons why a product may be in the wrong place. One common reason is the incorrect placement of the product by those who stock the product in the store. Because so many products look very similar, it is generally necessary for the store employee to carefully check the product and match it up with the UPC code label on the shelf where the item is to be placed. Another common problem is the fact that when there are too many items of the product for the shelf space allocated for that product, the excess product may be placed in a different location until the stock of the product reduces sufficiently enough to allow it to be placed at its proper shelf location. Other problems occur as a result of a customer removing the product and then placing it back on the shelf, but in the wrong place. When a store employee notices the problem, he or she must carefully check the product to determine where its proper place is on the shelf. The stocking of a new store, starting with empty shelves, significantly exasperates this problem.

Proper product placement on the store or facility shelves generally takes a considerable amount of labor. In addition to the practical considerations discussed above, proper product placement may also necessary to comply with contractual obligations the retail store may have for shelf placement of a particular product and to ensure that any recalled product is promptly removed from the store. Therefore, what is needed is an improved system for locating products that reduces the amount of labor required for locating such products. The preferred system should be easy to use, adaptable to current product identifying systems, stores and other facilities, and be effective at accurately identifying the location of a variety of different products.

### SUMMARY OF THE INVENTION

The product locating system of the present invention solves the problems identified above. That is to say, the present invention discloses a system for quickly and accurately identifying the location for or of a product in a store or other facility. The product locating system of the present invention simplifies the process of locating where on a shelf a product should be placed and for identifying where in the store or facility the product can be found. The system of the present invention utilizes currently available technology and UPC codes and is adaptable for most presently configured stores, warehouses and other facilities. Use of the product locating system of the current invention will substantially improve the placement and locating of products on the shelf and reduce the amount of labor necessary to perform such tasks, as well as other associated tasks, including inventory control. In addition, use of the system of the present invention should not require any significant training or re-training of store employees to effectively utilize the system.

In the preferred embodiment, the product locating system of the present invention is comprised principally of one or more targeting devices strategically placed in the store or other merchandise facility, a central or main computer station having appropriate software and hardware (i.e., a personal computer), the UPC codes on the products and one or more scan guns. The targeting devices should be suitable for projecting a beam of light, such as a laser beam, to a desired location and be capable of being independently positioned by one or more self-contained motors, such as a stepper or servo motor. The wireless scan guns are configured to communicate with the main computer station, which in turn communicates with the targeting devices. This system can be in a daisy-chain or multidrop fashion. For full effectiveness, each targeting unit should be independently addressable from the main computer. If desired, the targeting units can be addressable from the scan gun so that it may access and position the targeting device. Preferably, targeting unit positioning data is stored in the main computer. The software in the main computer can then access different files for different positioning information. In the alternative configuration, the scan gun can move the targeting unit independent of the main computer, internally store that position information, and then relay the information via wire or wireless link to the main computer. Stored positions can also be stored in the targeting unit itself.

In use, the targeting units are placed in strategic locations throughout the store or facility so that it may access the products on the shelves. Typically, the preferred location for the targeting units is on the ceiling between rows of shelves. When a product is initially placed on the shelf (new inventory) or the location of an existing product is identified, the scan gun is used to scan the product's UPC code. The associated targeting device is moved by keypads or other device, such as a joystick, on the scan gun such that the light projecting from the targeting device points at the location on the shelf for the product. The location of the product, whether this is the proper (home) location or the back-up storage location, is stored in the main computer. Any other information regarding the product, such as security tags or expiration dates, are also entered. When the product needs to be located or additional product needs to be placed on the shelf, the store employee only needs to enter the UPC code, via keypad or scan entry, and the targeting unit will rotate and pivot as necessary to project the beam of light on the location of the product.

In an alternative embodiment, the product locating system of the present invention utilizes automatic positioning equipment such that the appropriate targeting unit will follow or move to the scan gun and automatically record the location of the product, eliminating the need to move the targeting device to the product location. In another alternative, the hand-held scan gun will be adaptable for receiving voice commands and transmitting those commands to the targeting unit and central computer.

Accordingly, the primary objective of the present invention is to provide a product locating system that overcomes the disadvantages associated with presently available systems for identifying the location of products in a store or other merchandise facility having one or more rows of different products.

It is also an important objective of the present invention to provide a product locating system that quickly and accurately identifies the location or locations of a specific product in a store or other merchandise facility.

It is also an important objective of the present invention to provide a product locating system having a targeting unit, computer system and scan gun capable of operating in conjunction with presently established UPC codes to identify the location of products.

It is also an important objective of the present invention to provide a product locating system having a strategically mounted targeting unit capable of projecting a beam of light to the location of a product on a shelf in a store or other merchandise facility in response to a command from a hand-held scan gun or a central computer system.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 illustrates the various components of the product locating system of the present invention in a store or other facility showing an illustrated beam of light directed at a product;

FIG. 2 is a top view of a portion of a store or facility layout illustrating use of a targeting unit in each aisle or row and between the ends of the aisles;

FIG. 3 is a top view of an alternative configuration for placement of the targeting units of the present invention on a track or other device allowing movement of the targeting unit between aisles or rows of products; and

FIG. 4 is a side view of a targeting unit of the present invention showing the pan and tilt features of the targeting units.

### DETAILED DESCRIPTION OF THE PREFERRED EMBODIMENTS

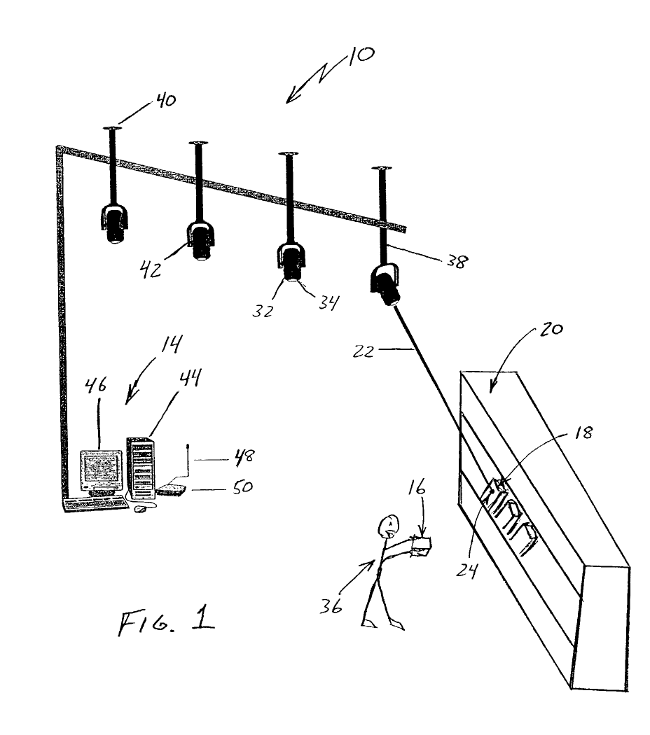

With reference to the figures where like elements have been given like numerical designations to facilitate the reader's understanding of the present invention, and particularly with reference to the embodiment of the present invention illustrated in FIGS. 1 through 4, the preferred embodiments of the present invention are set forth below. In the preferred embodiment, the product locating system of the present invention, identified generally as 10, principally comprises targeting units 12, a computer control system 14, a hand-held scan gun 16 and a UPC coded product 18 on a shelf 20 in a retail store or other merchandise facility, as best shown in combination in FIG. 1. As set forth in more detail below, targeting unit 12 is configured to project a light beam, illustrated as 22 in FIG. 1, to a light point 24 on product 18 in response to a command from the computer system 14 or scan gun 16 to identify the location of product 18 on the shelf 20. Although light beam 22 is shown as a solid line in FIG. 1, it can be comprised of either visible or invisible (to the human eye) light, as long as it is able to place light point 24 on product 18 or toward the location of product 18 (i.e., where product 18 is supposed to be).

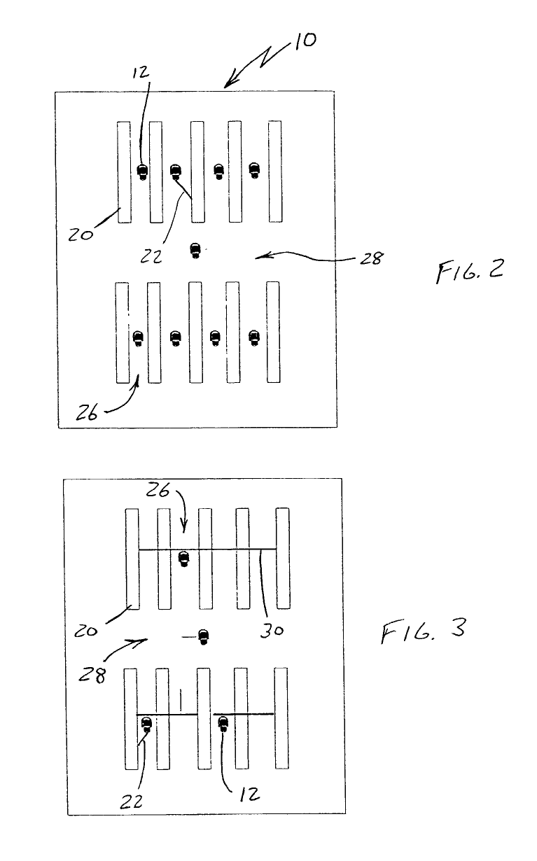

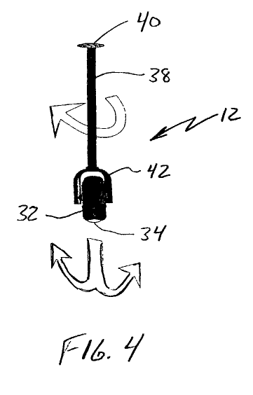

As shown in FIGS. 2 and 3, various placement possibilities exist for targeting unit 12 in the store. In FIG. 2, which is a top view of a store, a targeting unit is placed on the ceiling in each aisle or aisle 26 between rows of shelves 20 so as to be able to locate product 18 on shelf 20 or on the ceiling in the center aisle 28 between the rows of shelves 20 so as to locate product 18 on the ends of shelves 20. In FIG. 3, targeting unit 12 is slidably mounted on a track 30 over all or a portion of the plurality of aisles 26 so as to allow targeting unit 12 to slide over to the appropriate aisle 26 where product 18 is located. This configuration reduces the number of targeting units 12 necessary for the product locating system 10, but requires the use of a motorized apparatus to move targeting unit 12 to the proper aisle 26 and the proper computer control system 14 to control the sliding movement of targeting unit 12. Track 30 can be located perpendicular to shelves 20 at or near the middle of aisles 26 so as to reduce the amount of movement necessary for targeting unit 12 to be able to reach each product 18 on shelves 20.

Targeting unit 12 should have a housing 32 for enclosing a source of light 34 and the electromechanical components necessary to allow targeting unit 12 to pan and tilt, as shown in FIG. 4. Housing 32 can be made out of a variety of materials, including a good quality plastic or metal which can withstand the temperature generated by the light source 34 and motors (not shown). Housing 32 should be configured to keep dust and debris away from the various internal components of targeting unit 12. Because the system 10 is for use in retail stores, housing 32 should also be configured to make targeting unit 12 appear aesthetically pleasing. For instance, the ideal color of housing 32 would be close to the color of the typical fire resistant ceiling panels used on drop ceilings in most retail stores. This color allows targeting unit 12 to blend into the ceiling and not be too noticeable. However, any color is acceptable for the desired effect. If desired, targeting unit 12 can be configured to more closely resemble a security camera in order to serve as a possible theft deterrent to criminals who may mistake targeting unit 12 for a security device (i.e., camera). A slot can be built into the housing 32 near the front lens to support a small camera so that a camera could be placed on any aisle 26 or 28 for increased surveillance. The surveillance camera could be monitored and controlled from computer system 14 and connected to a video cassette recorder for recordation purposes.

Light source 34 should be able to handle precise positioning at long distances and, in the preferred embodiment, be powered by an external DC power supply. One good light source would be a laser or laser-type device, such as those commonly used in laser pointers. This type of laser displays a laser dot, such as light point 24 on the surface of product 18 on which it is being pointed. In contrast to the light beam included for illustrated purposes as a beam of light 22, most actual light beams 22 from targeting unit 12 to product 18 will not be visible to the naked eye. Other types of lights provide a beam of light 22 that is lit up so as to provide a visible trail from the targeting unit 12 to the light point 24 on product 18 that targeting unit 12 is pointing. One advantage of using a laser as light source 34 is that a relatively high intensity light can be used due to the lower heat given off by the laser. Naturally, light source 34 (i.e., the laser) needs to be safe so as not to do any damage to the products 18 or persons in the store, such as employee 36. A different color laser or a lens that changes the light from light source 34 could be useful for different functions. A lens that also changes the light beam 22 or laser into different shapes, words or pictures could also be useful to the user to project different shapes onto the location of the desired product 18.

Although not shown, but known within the art, there should be one or more motors or other positioning actuators in targeting unit 12 so that it can have a full range of pan and tilt motion. For instance, one motor can rotate targeting unit 12 left and right and another motor can be used to tilt targeting unit 12 up and down (i.e., up toward the ceiling and down to the floor). Preferably, the rotation of targeting unit 12 should be a full 360 degrees in the panning direction and a sufficient angle in the tilt direction so that it may direct light beam 22 toward any product 18 at any place in the designated area for that targeting unit 12, such as shelves 20. Because it is configured for use in a retail establishment, the motor or other actuator needs to be quiet so that it can be used during business hours without disturbing customers. A servo motor can probably handle the pan and tilt operations the best, although a stepper motor may also provide such capabilities. To keep the internal components of targeting unit 12 from getting too hot, it can include a quiet cooling fan, which should keep the components at a reasonable temperature so as to extend the life of the components.

If desired, a computer chip can be placed inside targeting unit 12 so that is possible to store information on the particular targeting unit 12 so that the scan gun could bypass the main computer system 14 and directly communicate with targeting unit 12. However, this could substantially increase the cost of targeting unit 12. A speaker could also be added to targeting unit 12 so that, in addition to the beam of light, the user could have sound capabilities so that after targeting unit 12 receives the appropriate information it can respond with beam of light 22 and sound. A small light can be placed on the outside of targeting unit 12 so that when a particular targeting unit 12 is in use, the light will turn on. Such an external light will indicate which aisle 26 or 28 that product 18 is on. If desired, targeting unit 12 can be activated from the front cash registers (i.e., by pressing a button) so that price checks can be more easily performed.

Targeting unit 12 should comprise a mounting apparatus that allows it to hang from the ceiling or other overhead surface and which permits the light source 34 to direct the light beam 22 in a pan and tilt direction. One such configuration is shown in FIG. 4. In this configuration, targeting unit 12 has an extension pole 38 that interconnects the ceiling mounting plate 40 with the bracket 42 for housing 32. The ceiling mounting plate 40 allows targeting unit 12 to be fixedly connected to the ceiling using bolts, screws or other connectors. Extension pole 38 can lower light source 34 from the ceiling to avoid drop ceilings or other obstructions. The length of extension pole 38 will depend on the height of the ceiling, height of the shelves 20, other store configuration considerations and preferences of the owner. In one configuration, bracket 42 is rotatably connected to extension pole 40 for panning and configured to allow housing 32 to tilt from a downward pointing direction to an upward pointing direction. In another configuration, extension pole 40 is rotatably connected to mounting plate 40 to rotate housing 32 for panning. The amount of panning and tilting necessary will depend on the configuration of the store and the height of the shelves 20 relative to the placement of targeting unit 12. Various other combinations of mounting apparatus components can be utilized to accomplish the objectives set forth herein. As described above, one alternative mounting apparatus has tracking unit 12 slidably attached to track 30 to allow tracking unit 12 to slide between (over) one or more rows of shelves.

Computer system 14 can include the facility's main computer, shown as 44 in FIG. 1, to store and operate the software needed to execute the various commands for targeting unit 12. The typical retailer already has one or more computers 44 that interact with RF types of equipment. The same computer 44 could hold the software needed for targeting unit 12. If computer memory is a problem, a separate computer can be utilized to operate the product locating system 10 of the present invention. Naturally, if a separate computer is used, it will be necessary for that it to communicate with the main computer 44 in order to share store and product information, such as the UPC numbers, prices and inventory. A monitor 46 is used with computer 44 so that a user may visually check on the status of targeting units 12 located throughout the store. In addition, monitor 46 will enable the user to access certain screens and perform functions from computer 44, such as self-tests of targeting units 12 and to check the performance of the system 10. In addition, monitor 46 will assist in downloading computer commands or programs to targeting units 12. An antenna 48 connected to communication device 50 should be used to have scan gun 16 communicate with computer 44 and/or targeting unit 12. The antenna 48 should be configured to send and receive information to and from scan gun 16. After antenna 48 receives information from the scan gun 16 or targeting device 12, it will send the information to computer 44 via communication device 50. Communication device 50 allows the computer to take the wireless transmission from scan gun 16 and properly relay it to computer 44 and send it back to scan gun 16. Computer 44 will read the data and send information back to the scan gun 16 or targeting device 12 via the same or, if preferred, a separate communication device 50.

Scan gun 16 can be of the type of hand held computer devices which are capable of reading UPC codes, such as a Telxon® or Symbol® gun. These guns are currently used by retailers to retrieve information on a product 18, such as the retail price, discounted prices, cost, order quantity, quantity on hand and description of the merchandise 18. The preferred scan gun 16 is a wireless hand-held unit that can communicate with computer system 14 and targeting unit 12 to position targeting unit 14 and identify locations in the store for the various products 18. If desired, scan gun 16 can include a keypad entry system, a mouse or joystick type of control mechanism and/or a touch screen for entering information and controlling targeting unit 12. In addition, scan gun 16 can include a monitor screen for viewing information received from computer system 14.

The software installed on computer 44, like any other software program, operates the system 10. The software should be capable of storing and retrieving all the pertinent product information on the computer and transmitting that information to the targeting units 12 and scan guns 16 as required. The first item that the software should search for is the UPC code on product 18 which was scanned by scan gun 16. This number will then open a file for that particular product 18. As discussed above, the computer 44 will already have information stored for the product 18, such as price and quantity on hand (i.e., inventory). The software should be configured to store additional information on the various products 18 in the store. When a product's UPC code is scanned using scan gun 16, computer 44 will search for this additional information on product 18, such as the main location, secondary locations, endcaps, overstock locations, when it expires and if it requires a security tag to be placed on the merchandise. All of this information will be sent to targeting unit 12 so that it will project the light beam 22 to the main location and prompt the user if additional attention is required.

In use, the product locating system of the present invention can be used for locating product 18 having a UPC or other code thereon in a facility by scanning the code with scan gun 16 and then transmitting information regarding product 18 from scan gun 16 to tracking unit 12. Tracking unit 12, having housing 32 enclosing light source 34, is mounted on an overhead surface in the facility and strategically positioned to be point at product 18 on shelves 20. On command, housing 32 is moved to point light source 34 toward the location of product 18 in the facility so as to project the beam of light 22 from light source 34 to product 18. In the preferred embodiment, the code read by scan gun 16 is transmitted to computer system 14 after it is scanned by scan gun 16 and then information pertaining to product 18 is transmitted to tracking unit 12 and/or scan gun 16.

An example of using the additional information to more efficiently operate the store with the system 10 of the present invention is for products that have expiration dates. With the product locating system 10, it is possible to enter the product's expiration date into scan gun 16 so that computer 44 can monitor the merchandise 18 more closely. The software will be able to track the quantity and dates of product 18 sold. If it identifies that there is a likelihood that particular merchandise 18 has expired or soon will expire, tracking unit 12 can be configured to point to the expired or soon to be expired merchandise 12 so that appropriate attention can be given to the product 18. With this system 10, the retailer will be able to more effectively keep expired products off his or her shelves 20 and, with soon to be expired product 18, give the retailer a chance to mark down the product 18 to more likely sell it before the product's expiration.

Another use for the present system 10 is if there is a possibility that one of several locations for a product will run out while the other remains full. The software can be configured to recognize that after a certain programmed quantity is sold, computer 44 will create an exception and communicate with targeting device 12 to point to the other locations so that they are checked, this will ensure that there are no product outages for that location, which could result in product 18 not being available for sale. If used, the external light on the side of housing 32 can blink for that aisle to indicate a possible problem that requires an associate to check. This same signal can be used to indicate product with expired or soon to be expired dates and with other “fault” type of indicators.

A number advantages exist by using the product locating system 10 of the present invention. One such advantage is faster stocking, because employee 36 will not have to search around to find the shelf location for product 18. The fact that the UPC code shelf sticker or product 18 is no longer on the shelf, will not create the location problems that currently exist. During the stocking process, targeting unit 12 can also be used to indicate to the person stocking that a security tag is required to be placed on product 18. To the extent prices are placed directly on the product 18, use of system 10 will allow the employee 36 to more quickly locate products 18 affected by a price increase and make the appropriate changes. In addition, any recalled products 18 can be more quickly found, including any recalled product 18 that is not kept at its primary location, which will reduce the likelihood that recalled product may be left behind for an inadvertent consumer sale. With the present system 10, signs and other display material promoting or otherwise conveying information about a product 18 can be more quickly and accurately placed near the product 18 to which it pertains. The present system 10 can be used to mark areas identified as problem areas during the restocking process, such as areas that have overstock, missing labels, outages, hazards or other product or store related problems. The system 10 can also be utilized to improve facing, the turning of the front of the product outward toward the shopper in the aisle, by pointing to areas in the store where quantities of the product 18 were sold so that an employee 36 can more efficiently move around the store and make sure the remaining inventory is properly faced. The system 10 also helps when having to clean up and restock products 18 that were taken off the shelf but not purchased, such as frequently occurs with toys. The system also reduces problems with incorrect stocking and improves the efficiency of having to restock items that were brought to the cash register but then not purchased (i.e., called go-backs). Because the system 10 does not rely on the visual appearance of the product for proper placement on shelves 20, it also reduces the problems and inefficiency caused by products that have very similar packaging, which can cause a product 18 to be improperly placed in proximity to similar types of products.

Additional embodiments can be incorporated into the system 10 of the present invention to adapt it to the particular needs of a certain type of store or other facility. For instance, direct cues, such as timing controls, speed controls and/or wait times for individual functions of the system 10 that are active in the cues, can be incorporated into the system 10. Voice recognition or other input mechanisms can be utilized to improve the efficiency of the system 10. A speaker, microphone and/or other audio devices can be incorporated into the targeting unit to allow a person at the computer system 14 station to verbally communicate with an employee 36 in the aisles 26 and 28. Incorporated into scan gun 16 can be a remote positioning device that communicates directly with targeting units 12 such that movement of scan gun 16 will result in movement of the associated targeting unit 12 without the necessity of the employee 36 having to enter commands on the scan gun 16 to move targeting unit 12. An example of such a system is the HA60 AR—Argos Series (from Skytron Surgical out of Grand Rapids, Mich.), a powered adjustable recessed lighting system having remote positioning wands that automatically control the position of an overhead light. This same technology could be incorporated into targeting unit 12 and scan gun 16 of the present invention.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A product locating system for locating a product having a code thereon in a facility, said product locating system comprising:
a targeting unit having a housing enclosing a light source, said targeting unit adapted for pointing said light source toward said product, said light source configured to project a beam of light toward the location of said product in said facility;
a computer system in communication with said targeting unit; and
a scan gun configured to scan said code on said product, said scan gun in communication with said targeting unit and said computer system.

2. The product locating system according to claim 1, wherein said targeting unit is mounted on an overhead surface in said facility.

3. The product locating system according to claim 1 further comprising a mounting apparatus to mount said housing to an overhead surface in said facility, said mounting apparatus configured to pan and/or tilt said housing.

4. The product locating system according to claim 3, wherein said mounting apparatus slidably mounts said targeting unit to a track.

5. The product locating system according to claim 3, wherein said mounting apparatus comprises a bracket pivotally connected to said housing and a mounting plate mounting said bracket to said overhead surface.

6. The product locating system according to claim 5 further comprising an extension pole disposed between said bracket and said mounting plate, said bracket rotatably connected to said extension.

7. The product locating system according to claim 5 further comprising an extension pole disposed between said bracket and said mounting plate, said extension pole rotatably connected to said mounting plate.

8. The product locating system according to claim 1, wherein said light source is a laser.

9. The product locating system according to claim 1, wherein said light source is configured to place a light point on said product.

10. The product locating system according to claim 1, wherein said scan gun is configured to transmit commands to said targeting unit to move said housing so as to point said light source toward said product.

11. The product locating system according to claim 1, wherein said scan gun is configured to transmit said code to said computer system and to receive information concerning said product from said computer system.

12. A product locating system for locating a product having a code thereon in a facility, said product locating system comprising:
a targeting unit having a housing enclosing a light source, said targeting unit adapted for pointing said light source toward said product, said light source configured to project a beam of light toward the location of said product in said facility;
a mounting apparatus to mount said housing to an overhead surface in said facility, said mounting apparatus configured to pan and/or tilt said housing;
a computer system in communication with said targeting unit; and
a scan gun configured to scan said code on said product, said scan gun in communication with said targeting unit and said computer system, said scan gun configured to transmit commands to said targeting unit to move said housing so as to point said light source toward said product.

13. The product locating system according to claim 12, wherein said mounting apparatus slidably mounts said targeting unit to a track.

14. The product locating system according to claim 12, wherein said mounting apparatus comprises a bracket pivotally connected to said housing and a mounting plate mounting said bracket to said overhead surface.

15. The product locating system according to claim 12, wherein said scan gun is configured to transmit said code to said computer system and to receive information concerning said product from said computer system.

16. The product locating system according to claim 12, wherein said light source is configured to place a light point on said product.

17. A method for locating a product having a code thereon in a facility, comprising the steps of:
a. scanning said code with a scan gun;
b. transmitting information regarding said product from said scan gun to a tracking unit mounted on an overhead surface in said facility, said tracking unit having a housing enclosing a light source;
c. moving said housing to point said light source toward the location of said product in said facility; and
d. projecting a beam of light from said light source to said product.

18. The product locating system according to claim 17 further comprising the step of transmitting said code to a computer system in communication with said scan gun after said scanning step.

19. The product locating system according to claim 17, wherein said transmitting step includes transmitting said code to a computer system in communication with said scan gun and transmitting information from said computer system to said tracking unit.

20. The product locating system according to claim 17, wherein said tracking unit comprises a mounting apparatus to mount said housing to said overhead surface, said mounting apparatus configured to pan and/or tilt said housing.
